(19) United States
(12) Patent Application Publication
(10) Pub. No.: US 2014/0236641 A1
(43) Pub. Date: Aug. 21, 2014

(54) System for Facilitating Travel Related Transactions

(71) Applicant: Mark C. Dawkins, Athens, GA (US)

(72) Inventor: Mark C. Dawkins, Athens, GA (US)

(21) Appl. No.: 13/771,427

(22) Filed: Feb. 20, 2013

(51) Int. Cl. G06Q 10/02

(52) U.S. Cl. CPC G06Q 10/02
USPC 705/5

(57) ABSTRACT

In a method for executing travel transactions, at least one packet is received at a central server from a remote computer. The travel packet includes a parameter describing a travel-related object and a conditional offer for purchase of the travel-related object made by a user. At a selected time, at least one target criteria for the travel-related object is generated. The conditional offer is compared to the target criteria. A communication of a time-limited offer specifying a time period within which the offer may be accepted, corresponding to the conditional offer, is transmitted to the remote computer via the global computer network only when the conditional offer meets the target criteria. A transaction is executed in which the travel-related object is transferred to the user only when a communication indicating an acceptance by the user is received at the central server computer within the time period.

### BACKGROUND OF THE INVENTION

1. Field of the Invention

The present invention relates to electronic contracting systems and, more specifically, to an electronic contracting system employed in the travel industry.

2. Description of the Related Art

Travel-related objects are regularly purchased electronically, such as via the global computer network. Certain systems have “name your own price” sites, wherein a user enters desired parameters for such objects as airline tickets, hotel stays and car rentals and a price that the user is willing to pay. If a supplier of such a service is willing to accept the offered price, then the system will make a purchase of the object on behalf of the user using the user's pre-entered credit card information.

Other sites allow a user to enter information about what the user wants in a travel-related object, such as an airline ticket to a certain destination on a certain date. The site will then display the current fare for the object of the user's search. However, travel fares often change quite quickly and sometimes special fares are available for only a limited amount of time, such as just a few hours. Users of such sites, in order to get a desired deal, often log onto the sites several times per day in hopes of accessing the site during the time a special fare is offered. This can waste valuable time on the part of the user and there is still a probability that the user will miss out on the special fare.

Some users also are interested in purchasing a travel-related object, but they are reluctant to commit to a current ticket price, expecting it to go lower. Such users often have a desired price in mind. For example, a traveler might wish to fly from Seattle to Chungsan on a certain date. The user might be unwilling to pay a current ticket fare of $1000 for that date, but might be willing to purchase a ticket for $800. The airline might not currently find such a fare to be acceptable, but might be willing to accept it at a later date when seat availability data may indicate it to be a profitable fare. Currently, no system provides a way for users to provide input to providers regarding desirable travel-related object prices.

Also, travel object providers, such as airlines, cruise lines, hotels, restaurants, car rental agencies, theme parks, attractions and events, exert a great deal of effort in determining optimal price points for the travel-related objects that they sell. The price points often change over very short periods of time, depending upon estimates of demand determined by the providers. Such estimates are based on such information as percentage of available objects already sold, historical buying trends and external events, such as weather. While these estimates can give rise to an effective price point, they usually leave out real-time information regarding how much users are willing to pay for a travel-related object. This can result in a market mismatch, which may make a given price point sub-optimal.

Therefore, there is a need for a system that receives desired price information from purchasers of travel-related objects.

### SUMMARY OF THE INVENTION

The disadvantages of the prior art are overcome by the present invention which, in one aspect, is a method, operable on a central server computer operated by a travel provider that is coupled to a global computer network, for executing travel transactions. At least one packet is received at the central server computer from a remote computer via the global computer network. The travel packet includes a parameter describing a travel-related object and a conditional offer for purchase of the travel-related object made by a user. The conditional offer is stored in a database on a computer-readable memory associated with the central server. At a selected time, at least one target criteria for the travel-related object is generated. The conditional offer stored in the database is compared to the target criteria. A communication of a time-limited offer specifying a time period within which the offer may be accepted, corresponding to the conditional offer for the travel-related object is transmitted to the remote computer via the global computer network only when the conditional offer meets the target criteria. A transaction is executed in which the travel-related object is transferred to the user only when a communication indicating an acceptance by the user is received at the central server computer within the time period.

In another aspect, the invention is a central server for executing travel transactions, operable by a travel provider and coupled to a global computer network. The central server includes a processor, a tangible computer-readable memory in data communication with the processor and a program, stored on the computer-readable memory. The program is configured to instruct the processor to execute a set of instructions, including: receive, at the central server computer from a remote computer via the global computer network, at least one packet including a parameter describing a travel-related object and a conditional offer for purchase of the travel-related object made by a user; store the conditional offer in a database on a computer-readable memory associated with the central server; at a selected time, generate at least one target criteria for the travel-related object; compare the conditional offer to the target criteria; issue a time-limited offer specifying a time period within which the offer may be accepted, corresponding to the conditional offer for the travel-related object to the user via the global computer network only when the conditional offer meets the target criteria; and execute a transaction in which the travel-related object is transferred to the user only when an acceptance by the user is received at the central server computer within the time period.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of one embodiment of a system for executing travel-related transactions.

FIG. 2A is a schematic diagram of one embodiment of a travel object search screen.

FIG. 2B is a schematic diagram of one embodiment of a travel object availability screen.

FIG. 2C is a schematic diagram of one embodiment of a travel object bid submission screen.

FIG. 3 is a schematic diagram of one embodiment of a conditional offer e-mail.

FIG. 4 is a flow chart demonstrating one method of operating a travel object transaction system.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

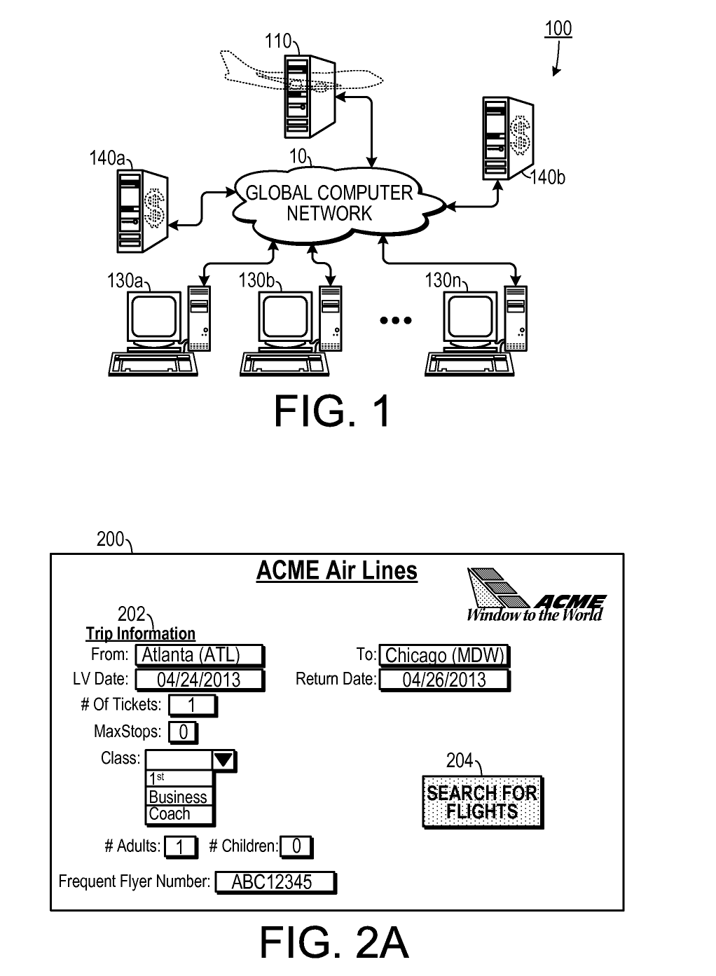

As shown in FIG. 1, one embodiment of a system for executing travel-related transactions 100 employs a central server 110 that includes a processor and a tangible computer readable memory, such as a disk drive, a flash drive, and the like. The central server 110 is configured to host at least one remote travel-related site operated by a travel-related company (such as an airline, a rental car company, a cruise line, a hotel chain, a tour company, an event company, and the like), which can be accessed by a plurality of user-operated remote computers 130a-130n via a global computer network 10. A user's financial institution 140a can be accessed via the global computer network 10. The user's financial institution 140a could include, e.g., a credit card company, a bank, an online payment processing company, or any institution capable of transferring funds as a result of a computer-initiated request. A system financial institution 140b can also be accessed for the purpose of transferring funds from a user's financial institution 140a into a system account belonging to a travel-related company.

The present invention allows users to provide bids for travel-related objects to a provider of such objects and allows the provider to consider the bids at a time selected by the provider. The provider uses the information to make time-limited offers to the users, thereby achieving an optimal price point that is acceptible to both the users and the provider. This results in a reduction of the provider's travel-related object inventory in a profitable and efficient manner.

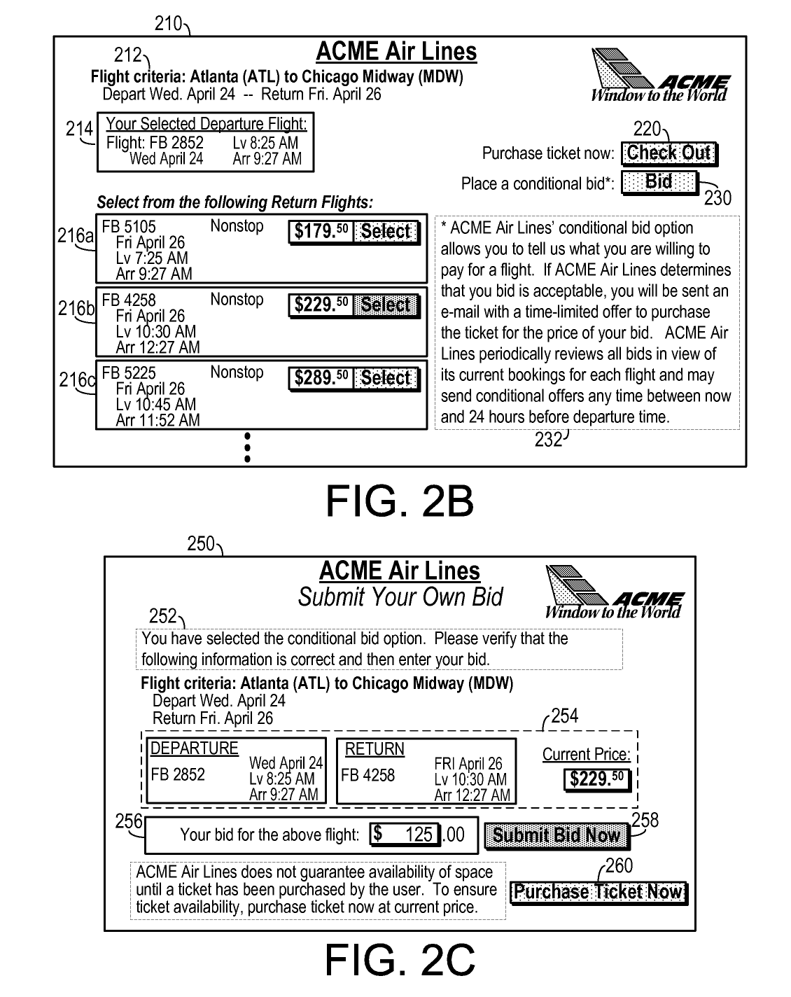

As shown in FIGS. 2A-2C, when a user accesses a website of a travel object provider (such as an airline in the example shown), the user is initially presented with a search screen 200 on which the user enters information 202 about the type of travel object that the user desires. For example, in the airline ticket context, the user would enter such information as: the departure location, the destination, the departure date, the return date, the number of tickets desired, the maximum number of stops desired, the desired class, the number of children and adults flying and the user's frequent flyer number. The search screen 200 also includes a button 204 that causes a search for the desired travel object to be conducted. Once button 204 is clicked, then a data packet with the trip information 202 will be sent to the server operated by the travel object provider. Examples of the travel-related objects to which this system could apply include: an airline ticket, a cruise ticket, a hotel room reservation, a rental car reservation, a theme park ticket, a lift ticket, an attraction ticket, a tour ticket, a vacation home rental reservation, an object purchased as part of: a travel plan, a business plan, a leisure plan and an entertainment plan, restaurant reservation, a beach cabanna reservation and many other types of travel-related objects.

Additional information that could be requested by this screen 200 could include such information as: alternate acceptable departure locations, acceptable alternate destination locations, alternate acceptable departure and return dates, maximum layovers, seat choice preference, seat location preference, type of plane, age of children, passenger names, passenger dates of birth, passenger gender, passenger telephone number, passenger address, discount/promotion codes, etc. In the car rental context, it could include automobile preferences such as: make, model, size, dropoff location, etc. In the hotel reservation context, it could include information about desired room size, amenities, number and type of beds, whether the room has an ocean/mountain view, dining plans, etc. In the cruise line context, it could include stateroom location preferences and dining time and table assignment preferenes, and any other related types of information. As will be readly understood by those of skill in the art, it could include many other types of information.

The server will conduct a search of a database and determine which travel objects meet the criteria set forth by the user. Once the search is completed, the server sends to the user a travel object availability screen 210 that lists the available travel objects meeting the user's criteria 212 and allows the user to purchase the travel object. As shown in FIG. 2B, in the airline embodiment, the user is presented with both departure flights 214 (in the example shown, the user has already selected a departure flight) and return flights 216a-c, from which the user can select a flight (in the example shown, the user has selected flight 216b). Once the travel objects have been selected by the user, the user is offered the option of either clicking a “Check Out” button 220, which would cause the user to be presented with a payment screen, or a “Bid” button 230. The screen could also include a text portion 232 that would explain the bidding process.

When the user selects the “Bid” button 230, as shown in FIG. 2C, the user is presented with a screen 250 that allows the user to submit a bid, which is a conditional offer, for purchase of the travel object. This screen 250 would typically include instructional text 252; a listing of the travel objects subject to the bid 254; a bid entry field 256, which allows the user to enter a proposed bid price; and a “Submit Bid Now” button 258, which causes the bid entered in field 256 to be submitted to the server. The user may also have the option to purchase the travel object at the current listed price by clicking a “Purchase Ticket Now” button 260.

Once the “Submit Bid Now” button 258 has been clicked, a data packet with information about the bid (including an identification of the travel objects subject to the bid, an identification of the user and the price of the bid) is sent to the server, which stores the bid in a computer-readable memory. At some point in the future, the travel object provider will decide that it desires to sell a certain number of the travel objects at a price less than a previous asking price. At that time, it will examine the bids in the database for the travel objects and determine which of the bids are acceptable. It may do this by using a valuation algorithm to set predetermined criteria. In the alternative, if it desires to sell a fixed number of travel objects quickly, then it will examine the bids within that fixed number from the top bid to determine its offer criteria.

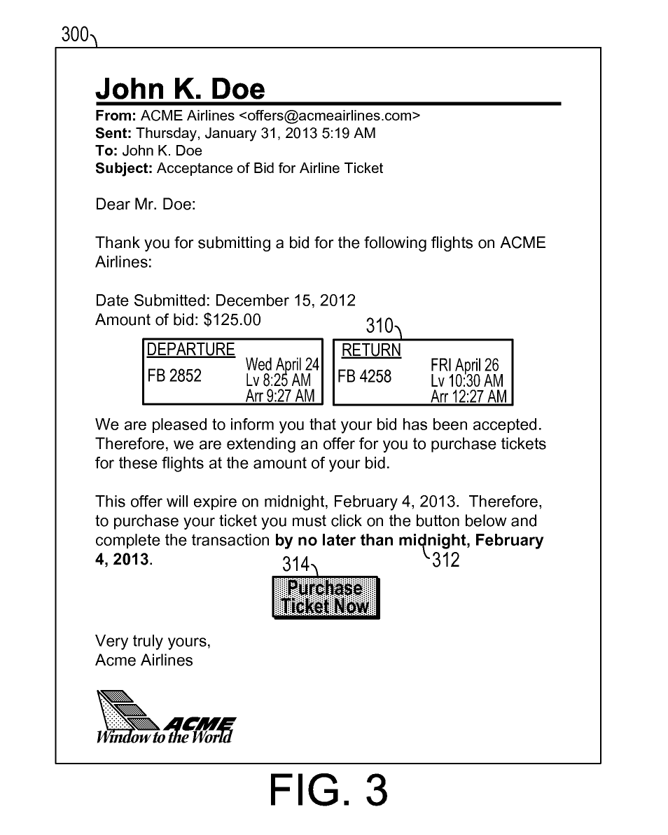

To each of the bidders that meet the criteria, it will send a communication (such as an e-mail 300), as shown in FIG. 3, setting forth a time-limited offer for sale of the travel object at the user's bid price. The communication 300 will include an identification of the travel objects subject to the offer 310, the bid price and instructions on how to complete the transaction. The instructions will include a deadline date by which time the time-limited offer must be accepted 312. If the offer is not accepted by the deadline, then the offer will expire. If the communication takes the form of an e-mail 300, it may also include a button 314 that, when clicked, directs the user to a purchase screen on the travel object provider's website.

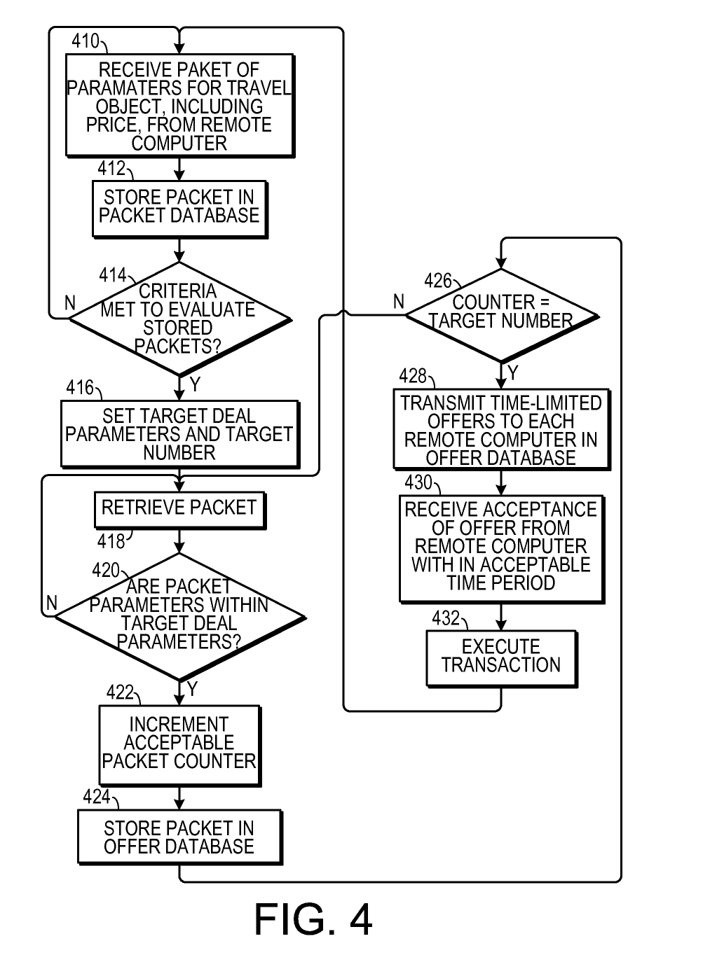

As shown in FIG. 4, in one method of effecting a travel object bid and sale after an initial search has been made by a user, the system receives a data packet that includes data describing desired travel object parameters from a user at a remote computer 410. Information in the packet includes an identification of the desired travel object, identification of the user and a bid price for the travel object submitted by the user. The data packet is stored in a database 412. The system will determine if predetermined criteria have been met to cause it to evaluate the stored data packets 414. To make this determination, the travel object provider might evaluate whether the travel object must be sold within a predetermined amount of time and might also examine sales trends and projected demand for the travel object. For example, in the airline context if a flight from Atlanta to Chicago is scheduled for April 24 and it is three weeks before April 24, then the airline might determine that the current number of seats available exceeds the number of seats that it had previously expected to have available three weeks before April 24. In that case, it might desire to sell the excess number of seats at a discount and would, therefore decide to evaluate the bids in the stored packets.

The travel object provider would then set target parameters for the deals it subsequently decides to offer 416. The target parameters could include the number of travel objects it is willing to offer at user-bid prices and a minimum acceptable price. To do this, the system will retrieve a first packet 418 and determine if the bid in the packet meets the target parameters 420. If not, it will return to step 418, otherwise it will increment a counter 422 indicating the number of packets that meet the target criteria and then store the packet in a database of offers to be made 424. Next, the system will determine if it has met its target number of packets 426 for this cycle of offers. If not, it returns to step 418, otherwise the system will transmit time limited offers to the remote computer of each user whose bid packets have been stored in the offer database 428. When the system receives an acceptance of an offer from the remote computer of the user who has been sent a time limited offer within the time period set forth in the offer 430, the system will then execute a transaction 432 in which the system transfers the travel-related object subject of the offer to the user and will receive payment of the travel-related object. The system can also at any time transmit to a user an offer that includes a price that is different from the user's bid, but that can result in an immediate purchase. Such offer could be for less that the currently published price. The system can also give special weight to certain users when deciding whether to transmit an offer. For example, an airline might decide to reward a user with a high number of frequent flyer points by accepting that user's bid before other users making the same bid.

Payment might be effected by one of the many ways online payments are made, including: a credit card transaction; a payment website transaction (e.g., PayPal® transaction); a direct bank transfer from a user's account to the provider's account via an electronic funds transfer system; the sending of an invoice, etc. The travel object may be transferred to the user through one of the many ways travel objects are transferred, including: e-mailing a ticket, a voucher, a reservation confirmation or other purchase confirmation document to the user; providing a link to a website at which the user can download a ticket or a voucher; mailing a ticket or a voucher to the user; providing the user a confirmation number that will entitle the user to receive a ticket or a voucher at a ticketing kiosk or counter upon arrival at an airport, cruise embarkation point, hotel, rental car location, attraction or event ticket booth, etc.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method, operable on a central server computer operated by a travel provider that is coupled to a global computer network, for executing travel transactions, comprising the steps of:
(a) receiving, at the central server computer from a remote computer via the global computer network, at least one packet including a parameter describing a travel-related object and a conditional offer for purchase of the travel-related object made by a user;
(b) storing the conditional offer in a database on a computer-readable memory associated with the central server;
(c) at a selected time, generating at least one target criteria for the travel-related object;
(d) comparing the conditional offer stored in the database to the target criteria;
(e) transmitting to the remote computer a communication of a time-limited offer specifying a time period within which the offer may be accepted, corresponding to the conditional offer for the travel-related object via the global computer network, only when the conditional offer meets the target criteria; and
(f) executing a transaction in which the travel-related object is transferred to the user only when a communication indicating an acceptance by the user is received at the central server computer within the time period.

2. The method of claim 1, wherein further comprising the steps of:
(a) receiving, at the central server computer from a remote computer via the global computer network, at least one travel object search input;
(b) after receiving the travel object search input, transmitting to the remote computer via the global computer network a screen that includes a button that, when activated, directs the remote computer to a screen that allows the user to input the conditional offer.

3. The method of claim 1, wherein further comprising the steps of:
(a) receiving conditional offers from a plurality of remote computers; and
(b) transmitting via the global computer network a communication of the time-limited offer to a subset of the plurality of remote computers.

4. The method of claim 1, wherein the executing step comprises the steps of:
(a) transferring funds from a first account belonging to the user to a second account belonging to the travel provider through an electronic transfer system; and
(b) transmitting the travel-related object to the user.

5. The method of claim 1, further comprising the step of transmitting to the remote computer an immediate offer for the travel-related object immediately after receiving the at least one packet that is different from the conditional offer by which the user can accept the immediate offer to purchase the travel-related object.

6. The method of claim 1, wherein the travel-related object comprises an object selected from a group consisting of: an airline ticket, a cruise ticket, a hotel room reservation, a rental car reservation, a theme park ticket, a lift ticket, an attraction ticket, a tour ticket, a vacation home rental reservation, an object purchased as part of: a travel plan, a business plan, a leisure plan or an entertainment plan, and combinations thereof.

7. The method of claim 1, further comprising the step of transferring a document confirming purchase of the travel-related object to the remote computer.

8. The method of claim 7, wherein the document comprises a document selected from a list of documents consisting of: a ticket, a reservation, a voucher and combinations thereof.

9. The method of claim 1, wherein the parameter includes parameters selected from a list consisting of: acceptable departure locations; acceptable destination locations; leave date; return date; acceptable alternate dates; outbound flight window; return flight window; number of tickets; ticket class; number of stops; maximum layovers per stop; airline preferences; seat choice; seat location preference; type of plane; number of adults; number of children; age of children; passenger name; passenger date of birth; passenger gender; passenger telephone number; passenger address; frequent flyer number; discount/promotion codes and combinations thereof.

10. The method of claim 1, further comprising the step of evaluating current supply of the travel-related object and projected demand for the travel-related object, based at least in part on conditional offers stored in the database, so as to determine the selected time and the target criteria.

11. The method of claim 1, further comprising the step of collecting information from the user via the global computer network, the information selected from a group of information consisting of: acceptable departure locations; acceptable destination locations; leave date; return date; acceptable alternate dates; outbound flight window; return flight window; number of tickets; full orders only; whether partial orders are acceptable, number of tickets required to authorize purchase; ticket class; number of stops; maximum layovers per stop; airline preferences; seat choice; seat location preference; type of plane; number of adults; number of children; age of children; passenger name; passenger date of birth; passenger gender; passenger telephone number; passenger address; frequent flyer number; discount/promotion codes; and combinations thereof.

12. A central server for executing travel transactions, operable by a travel provider and coupled to a global computer network, the central server comprising:
(a) a processor;
(b) a tangible computer-readable memory in data communication with the processor; and
(c) a program, stored on the computer-readable memory and configured to instruct the processor to execute a set of instructions, including:
(i) receive, at the central server computer from a remote computer via the global computer network, at least one packet including a parameter describing a travel-related object and a conditional offer for purchase of the travel-related object made by a user;
(ii) store the conditional offer in a database on a computer-readable memory associated with the central server;
(iii) at a selected time, generate at least one target criteria for the travel-related object;
(iv) compare the conditional offer to the target criteria;
(v) issue a time-limited offer specifying a time period within which the offer may be accepted, corresponding to the conditional offer for the travel-related object to the user via the global computer network only when the conditional offer meets the target criteria and transmit the time-limited offer to the remote computer; and
(vi) execute a transaction in which the travel-related object is transferred to the user only when an acceptance by the user is received at the central server computer within the time period.

13. The central server of claim 12, wherein the program instructs the processor to execute the transaction by performing actions including:
(a) transfer funds from a first account belonging to the user to a second account belonging to the travel provider through an electronic transfer system; and
(b) transmit the travel-related object to the user.

14. The central server of claim 12, wherein the program further instructs the processor to transmit to the remote computer an immediate offer for the travel-related object immediately after receiving the at least one packet that is different from the conditional offer by which the user can accept the immediate offer to purchase the travel-related object.

15. The central server of claim 12, wherein the travel-related object comprises an object selected from a group consisting of: an airline ticket, a cruise ticket, a hotel room reservation, a rental car reservation, a theme park ticket, a lift ticket, an attraction ticket, a tour ticket, a vacation home rental reservation, an object purchased as part of: a travel plan, a business plan, a leisure plan or an entertainment plan, and combinations thereof.

16. The central server of claim 12, wherein the program instructs the processor to transfer a document confirming purchase of the travel-related object to the remote computer.

17. The central server of claim 16, wherein the document comprises a document selected from a list of documents consisting of: a ticket, a reservation, a voucher and combinations thereof.

18. The central server of claim 12, wherein the parameter includes parameters selected from a list consisting of: acceptable departure locations; acceptable destination locations; leave date; return date; acceptable alternate dates; outbound flight window; return flight window; number of tickets; ticket class; number of stops; maximum layovers per stop; airline preferences; seat choice; seat location preference; type of plane; number of adults; number of children; age of children; passenger name; passenger date of birth; passenger gender; passenger telephone number; passenger address; frequent flyer number; and discount/promotion codes and combinations thereof.

19. The central server of claim 12, further comprising the step of evaluating current supply of the travel-related object and projected demand for the travel-related object, based at least in part on conditional offers stored in the database, so as to determine the selected time and the target criteria.

20. The central server of claim 12, wherein the program further instructs the processor to collect information from the user via the global computer network, the information selected from a group of information consisting of: acceptable departure locations; acceptable destination locations; leave date; return date; acceptable alternate dates; outbound flight window; return flight window; number of tickets; full orders only; whether partial orders are acceptable, number of tickets required to authorize purchase; ticket class; number of stops; maximum layovers per stop; airline preferences; seat choice; seat location preference; type of plane; number of adults; number of children; age of children; passenger name; passenger date of birth; passenger gender; passenger telephone number; passenger address; frequent flyer number; discount/promotion codes; and combinations thereof.

21. The central server of claim 12, wherein the program further instructs the processor to execute instructions including:
(a) receive, at the central server computer from a remote computer via the global computer network, at least one travel object search input;
(b) after receiving the travel object search input, transmit to the remote computer via the global computer network a screen that includes a button that, when activated, directs the remote computer to a screen that allows the user to input the conditional offer.

22. The central server of claim 12, wherein the program further instructs the processor to execute instructions including:
(a) receive conditional offers from a plurality of remote computers; and
(b) transmit via the global computer network a communication of the time-limited offer to a subset of the plurality of remote computers.
